(19) United States
(12) Patent Application Publication
(10) Pub. No.: US 2025/0075105 A1
(43) Pub. Date: Mar. 6, 2025

(54) ANTIFOAMER FOR GRINDING OR POLISHING COMPOSITIONS AND METHODS FOR USING THE SAME

(71) Applicant: LaPel, LLC, Vancouver, WA (US)

(72) Inventors: Larry Lindland, Camus, WA (US); Alan LoPresti, Vancouver, WA (US); James Berglund, Vancouver, WA (US); Katherine Ratliff, Vancouver, WA (US)

(73) Assignee: LaPel, LLC, Vancouver, WA (US)

(21) Appl. No.: 18/915,663

(22) Filed: Oct. 15, 2024

Related U.S. Application Data
(63) Continuation of application No. PCT/US2023/065993, filed on Apr. 20, 2023.
(60) Provisional application No. 63/363,278, filed on Apr. 20, 2022.

(51) Int. Cl. C09G 1/04

(52) U.S. Cl. CPC C09G 1/04

(57) ABSTRACT

Compositions comprising an alkyloxylated decyne diol, a poly-alkylene glycol, and/or a polydimethylsilane are disclosed. Embodiments of the present disclosure may be useful for decreasing the quantity of foam present or generated in compositions used for ophthalmic lens generation and/or precision optical fabrication, for example during grinding or polishing steps.

### CROSS-REFERENCE TO RELATED APPLICATION

This application is a continuation of International Application No. PCT/US2023/065993 filed on Apr. 20, 2023, which claims the benefit of priority to U.S. Provisional Patent Application No. 63/363,278 filed on Apr. 20, 2022 each of which are hereby incorporated herein by reference in their entirety.

### BACKGROUND

Foam, a mass of small bubbles formed on or in liquid, and the presence or generation of the same, can be disruptive to manufacturing processes. In particular, foam can disrupt manufacturing processes used to grind or polish substrates. Therefore, there remains a need for improved compositions of matter and methods for reducing the presence or generation of foam during manufacturing processes.

### SUMMARY

In one embodiment, a composition of matter is disclosed comprising an alkyloxylated decyne diol, a polydimethylsiloxane, and/or a poly-alkylene glycol. In some embodiments, a composition of matter comprises an alkyloxylated decyne diol in a quantity of between 80 percent by weight to 90 percent by weight of the composition. In other embodiments, a composition may comprise an alkoxylated decyne diol between about 80 by weight to about 99.6% by weight.

In some embodiments, a composition comprises a polydimethylsiloxane in a quantity of between 1 percent by weight to 2 percent by weight of the composition.

In some embodiments, a composition comprises a poly-alkylene glycol in a quantity of between 5 percent by weight to 8 percent by weight of the composition.

In another embodiment, a method for reducing the quantity of foam in a composition of matter used for grinding or polishing ophthalmic lens or precision optical components is disclosed. In some embodiments the method comprises providing a first composition of matter comprising an alkyloxylated decyne diol, a polydimethylsiloxane, and/or a poly-alkylene glycol; providing a second composition of matter; and adding the first composition of matter to the second composition of matter. In some embodiments, a second composition of matter may comprise water, or a coolant fluid.

In still another embodiment, methods for grinding or polishing a substrate are disclosed. In some embodiments, a substrate being ground or polished may comprises glass, automotive glass, flat glass, ophthalmic glass, precision ophthalmic glass, ceramics, quartz, solar glass, optical glass, precision optical substrates, lens glass, architectural glass, curtain wall glass, appliance glass, electronic-device glass, and/or plastics such as, but not limited to, ophthalmic plastics.

Additional embodiments of the invention, as well as features and advantages thereof, will be apparent from the descriptions herein.

### DETAILED DESCRIPTION

For the purposes of promoting an understanding of the principles of the invention, reference will now be made to certain embodiments and specific language will be used to describe the same. It will nevertheless be understood that no limitation of the scope of the invention is thereby intended, such alterations and further modifications, and such further applications of the principles of the invention as described herein being contemplated as would normally occur to one skilled in the art to which the invention relates. Additionally, in the detailed description below, numerous alternatives are given for various features. It will be understood that each such disclosed alternative, or combinations of such alternatives, can be combined with the more generalized features discussed in the Summary above, or set forth in the embodiments described below to provide additional disclosed embodiments herein.

In one embodiment, a composition of matter is disclosed comprising an alkyloxylated decyne diol, a polydimethylsiloxane, and/or a poly-alkylene glycol. In some embodiments, a composition of matter comprises an alkyloxylated decyne diol in a quantity of between 80 percent by weight to 90 percent by weight of the composition or between about 80 by weight to about 99.6% by weight.

In some embodiments, a composition comprises a polydimethylsiloxane in a quantity of between 1 percent by weight to 2 percent by weight of the composition.

In some embodiments, a composition comprises a poly-alkylene glycol in a quantity of between 5 percent by weight to 8 percent by weight of the composition.

In some embodiments, an alkyloxylated decyne diol may comprise SURFYNOL® MD-20 manufactured by Evonik. In certain embodiments, the alkyloxylated decyne diol comprises the product or products of [(2-Ethylhexyl)methyl]oxirane reacted with polyethylene glycol and 2,4,7,9-Tetramethyl-5-decyne-4,7-diol.

In some embodiments, a composition of matter may comprise aminoethyl propane diol, a glycol ether, a polydimethylsiloxane and/or a combination thereof.

In certain preferred embodiments, when used, an aminoethyl propane diol may comprise 2-amino-2-ethyl-1,3-propanediol. Some aminoethyl propane diols are available commercially and marketed as AEPD™ 85 by ANGUS Chemical Company and/or AEPD-VOX-1000 by ANGUS Chemical Company.

In certain embodiments, when used, a glycol ether may comprise a polyalkylene glycol. For example, is some embodiments, the glycol ether may comprise polypropylene glycol monobutyl ether. In other embodiments, a glycol ether may comprise polypropylene glycol monobutyl ether polymers with a viscosity between 65 and 1750 Saybolt Universal Seconds. Some polyalkylene glycols are available commercially and marketed as LB-65 by Dow (“UCON™ Lubricant LB-65”) and LB-285 (“UCON™ Lubricant LB-285”) by Dow.

In certain embodiments, the alkyloxylated decyne diol may comprise between 80 percent by weight to 99.6 percent by weight of the composition; between 90 percent by weight to 99.6 percent by weight of the composition; between 95 percent by weight to 99.6 percent by weight of the composition; between 98 percent by weight to 99.6 percent by weight of the composition; and/or between 99.0 percent by weight to 99.6 percent by weight of the composition.

Compositions of the present disclosure may include an additive, such as aminoethyl propane diol, a glycol ether, a polydimethylsiloxane, and/or a combination thereof. In certain embodiments, the total percentage by weight of all additives may comprise between 0.2 percent by weight to 5 percent by weight of the composition; between 0.2 percent by weight to 4 percent by weight of the composition; between 0.2 percent by weight to 3 percent by weight of the composition; between 0.2 percent by weight to 2 percent by weight of the composition; and/or between 0.2 percent by weight to 1 percent by weight of the composition.

In another embodiment, a method for reducing the quantity of foam in a composition of matter used for grinding or polishing ophthalmic lens or precision optical components is disclosed. In some embodiments the method comprises providing a first composition of matter comprising an alkyloxylated decyne diol, a polydimethylsiloxane, and/or a poly-alkylene glycol; providing a second composition of matter (sometimes referred to herein as a “base coolant”); and adding the first composition of matter to the second composition of matter. In some embodiments, the first composition of matter may be directly added to the second composition of matter and/or may be added as a tank side addition.

In some preferred embodiments, the compositions of matter may comprise no oils or other types of hydrocarbons. In some preferred embodiments, the compositions of matter may be used at significantly reduced application levels, for example at between 20 to 50 times less material as compared to standard materials used in the industry for reducing or preventing the formation of foam.

In still another embodiment, methods for grinding or polishing a substrate are disclosed. In some embodiments, a substrate being ground or polished may comprises glass, automotive glass, flat glass, ophthalmic glass, precision ophthalmic glass, ceramics, quartz, solar glass, optical glass, precision optical substrates, lens glass, architectural glass, curtain wall glass, appliance glass, electronic-device glass, and/or plastics such as, but not limited to, ophthalmic plastics.

Without being bound to any particular theory or mechanism of action, it is believed that the compositions disclosed and described herein may improve the compatibility of coolants or other liquids with ground particles that may be shed during grinding or polishing operations. Other impurities or non-virgin materials may be introduced to the same. For example, hydrocarbons such as greases or oils from machinery may be in contact with coolants or other process liquids. Other impurities or non-virgin materials that may be introduced during manufacturing processes include, but are not limited to foreign materials such as dust, dander, and/or hair as well as shards or smaller pieces from substrates being ground or polished. Such materials may contribute to the formation of foams.

In some situations, the formation of foam may increase as a coolant is used for a longer period of time. The compositions disclosed may be used as a coolant themselves or may be added to a coolant to refresh or rejuvenate a coolant so as to prolong the useful life of the coolant by reducing the quantity of foam that is formed, especially as a coolant ages. In some embodiments, the compositions disclosed herein may be added to a coolant. For example, in one embodiment one drop of a composition may be added to 1000 mL base coolant to reduce or prevent foam formation in the resulting composition. In other embodiments two, three, four, five, or six drops of a composition may be added to 1000 mL base coolant to reduce or prevent foam formation in the resulting composition.

In order to promote a further understanding of the present invention and its various embodiments, the following specific examples are provided. It will be understood that these examples are illustrative and are not limiting of the invention.

### Example 1—Procedure for Use of Foam Cell to Test for Foam

To measure foam, a foam cell may be used. As described and used in examples herein, the foam cell used comprises a clear PVC cylinder (3 inches in diameter, and about 18.75 inches tall) connected with 1 cm diameter flexible tubing from the bottom of the foam cell by a recirculating pump (Little Giant model 1-M D M0921) which cycles fluid from the bottom of the PVC tube to the top of the PVC tube through a total of about 36 inches of 1 cm diameter flexible tubing comprising a flow sensor to form a circulation loop where liquid is circulated from the bottom of the PVC tube to the top of the PVC tube.

Before use, the foam cell is confirmed to be clean by filling the cell with tap water to the 7 inch mark and running the cell for 5-20 minutes. The foam cell is considered clean if, after 5-20 minutes of continuous running with tap water, less than 0.125 inches of foam is generated and dispersed within 3 seconds. If more than 0.125 inches of foam is generated or if the foam takes more than 3 seconds to disperse, the foam cell is cleaned and re-tested with continuous running with tap water.

The foam cell circulation loop is closed, and material to be tested added to the 7.5 inch mark of the foam cell. The foam cell apparatus is started, and foam progression is observed, and the time elapsed for the foam to reach the 10 inch mark on the foam cell is recorded. The peak height of the foam observed within 5 minutes is recorded as well as the height of the foam at 5 minutes. The foam cell is turned off and the foam dispersion is observed. The time it takes for the majority of foam to disperse or reach 8 inches in height is recorded as well as the time elapsed for the remaining foam to disperse so that about one third of the surface of the liquid is completely free of foam. Immediately after observing the foam disperse, the foam cell is restarted and the above measurements are repeated two more times.

### Example 2—Procedure for Use of Blender to Test for Foam

As used in the examples herein, the blender used is a 5 speed Oster Duralast Classic blender (model BLSTSG).

A blender is cleaned by filling with tap water and pressing the “ice crush” button for 15 seconds. The blender is considered clean if, after 15 seconds on “ice crush” any foam generated is in the form of large bubbles which disperse nearly instantly and the body of the water is clear and free from entrained air. If the tap water has a milky or hazy appearance, or if any foam generated doesn't dissipate nearly instantly, the blender is rinsed.

The test sample is prepared and added to the blender vessel and a lid is placed on the vessel.

The “ice crush” button is depressed for 15 seconds, and a timer started. The foam is observed as it dissipates. When the foam is not in contact with the lid of the blender, the lid may be removed for casier observation. The following observations are made and recorded: (1) the time at which the large bubbles have dissipated, leaving only microbubbles behind; (2) the time at which a majority of the bubbles have dissipated; and/or (3) the time at which the speed of foam dispersion changes from a faster rate to a slower rate. Also observed is the time it takes a layer of entrained air within the fluid to rise above the tips of the blender blades. After two minutes have elapsed and after two minutes and fifty seconds, the height of the remaining foam is measured in millimeters. After three minutes have elapsed, the height of where a hazy or greyish layer of entrained air is located and is recorded.

### Example 3—Preparation of Compositions for Testing

he following materials were obtained and used in preparing various compositions for testing: Evonik Surfynol MD-20 (“MD-20”), an alkyloxylated decyne diol prepared by reacting [(2-Ethylhexyl)methyl]oxirane with polyethylene glycol and 2,4,7,9-Tetramethyl-5-decyne-4,7-diol; Dow LB-285 (“LB-285”), a poly-alkylene glycol described as polypropylene glycol monobutyl ether; Dow LB-65 (“LB-65”) a poly-alkylene glycol described as polypropylene glycol monobutyl ether; Angus AEPD™ 85 (“AEPD”) a aminoethyl propane diol, specifically 2-amino-2-ethyl-1,3-propanediol; BASF Foamaster (R) MO 2190 (“MO2190”) a product containing petroleum distillates and silica gel; DF 4100 made by Zhejiang New Vision Chemical Material Co. LTD (“DF 4100”) described as a acetylenic diol, specifically “Ethoxylated Modified Acetylenic Diol”; Evonik TEGO ANTIFOAM 2290 (“Tego 2290”); Huntsman Surfonic (R) JL-80X Surfactant (“JL-80X”); and polyoxyalkylene glycols used in embodiments described herein may be available commercially and may be marketed under trade names such as JEFFOX WL-5000 or UCON™ Lubricant. Polyoxyalkylene glycols used in embodiments described herein may be commercially marketed or sold by BASF or Clariant, and/or others, and may sometimes be described as an ethylene oxide/propylene oxide copolymer. For the testing described herein, UCON™ Lubricant 75-H-280,000, 40% AQ from Dow was used.

Composition A was prepared by mixing 99.70 percent by weight of MD-20 and 0.30 percent by weight LB-285. The average mass of a drop of Composition A was measured to be 0.029 grams per drop.

Composition B was prepared by mixing 99.70 percent by weight of MD-20 and 0.30 percent by weight LB-65. The average mass of a drop of Composition B was measured to be 0.033 grams per drop.

Composition C was prepared by mixing 99.50 percent by weight of MD-20, 0.49 percent by weight LB-65, and 0.01 percent by weight AEPD. The average mass of a drop of Composition C was measured to be 0.033 grams per drop.

Composition D was prepared by mixing 98.7 percent by weight MD-20, 0.3 percent by weight LB-285, 0.7 percent by weight Tego 2290, 0.2% by weight DF 4100, and 0.1% by weight AEPD. The average mass of a drop of Composition D was measured to be 0.032 grams per drop.

Composition E was prepared by mixing 98.7 percent by weight MD-20, 0.3 percent by weight LB-285, 0.2 percent by weight Tego 2290, 0.7 percent by weight DF 4100, and 0.1% by weight AEPD. The average mass of a drop of Composition E was measured to be 0.031 grams per drop.

Composition F was prepared by mixing 99.5 percent by weight MD-20, 0.3 percent by weight LB-65, and 0.2 percent by weight AEPD and is considered a preferred embodiment of the inventions disclosed herein. The average mass of a drop of Composition F was measured to be 0.031 grams per drop.

Test Coolant Fluid: 77.384 percent by weight water was mixed with 6.439 percent by weight triethyl amine, 3.587 percent by weight monoethanolamine (“MEA”), 2.357 percent by weight boric acid, 2.357 percent by weight sebacic acid, 7.861 percent by weight of UCON™ Lubricant 75-H-280,000, 40% AQ, and 0.015 percent by weight JL-80X to prepare a Test Coolant Fluid (“Test Coolant Fluid”).

Preparation of 15:1 (v/v) Test Coolant Fluid: 1030 mL water was measured using a graduated cylinder and added to a vessel. 68 mL of Test Coolant Fluid was measured using a 60 mL syringe in two portions and added to the vessel. The resulting composition was mixed in the vessel to prepare a 15:1 (v/v) Test Coolant Fluid composition (“15:1 Test Coolant Fluid”) that was used in foam cell tests and blender tests.

### Example 4—Testing Results Using Foam Cell

Foam Cell testing was performed according to the method described in Example 1 using Composition A and Composition F. For testing, cach run was prepared by adding 3 drops of the sample in 1030 mL 15:1 Test Coolant Fluid to generate the fluid that was tested and the results were observed. The results are summarized below in Table 1.

TABLE 1
Summary of Foam Cell testing of Composition
A and Composition Fin 15:1 Test Coolant.

| | | | Peak | | | | |
|---|---|---|---|---|---|---|---|
| | | | Foam | | | | |
| | | | Height | Foam | Initial | Final | |
| | | Time to | within | Height | dispersion | Dispersion | Height |
| | | reach 10 | 5 | at 5 | from 5 | from 5 | at 6 |
| | Test | inches | minutes | minutes | minutes | minutes | minutes |
| Sample | Fluid | (seconds) | (inches) | (inches) | (seconds) | (seconds) | (inches) |
| Composition | 15:1 | Not | 8.75 | 8.75 | 4 | 10 | 8.75 |
| A | Test | observed | | | | | |
| | Coolant | | | | | | |
| | Fluid | | | | | | |
| Composition | 15:1 | Not | 8.5 | 8.5 | 4 | 9 | 8.75 |
| F | Test | observed | | | | | |
| | Coolant | | | | | | |
| | Fluid | | | | | | |
| Composition | 15:1 | Not | 8.5 | 8.5 | 3 | 10 | 8.5 |
| A | Test | observed | | | | | |
| | Coolant | | | | | | |
| | Fluid | | | | | | |
| Composition | 15:1 | Not | 8.5 | 8.5 | 4 | 9 | 8.5 |
| F | Test | observed | | | | | |
| | Coolant | | | | | | |
| | Fluid | | | | | | |

| | | Initial | Final | | Initial | Final |
|---|---|---|---|---|---|---|
| | Height | Dispersion | Dispersion | Height | Dispersion | Dispersion |
| | at 10 | from 10 | from 10 | at 20 | from 20 | from 20 |
| | minutes | minutes | minutes | minutes | minutes | minutes |
| Sample | (inches) | (seconds) | (seconds) | (inches) | (inches) | (inches) |
| Composition | 8.75 | 4 | 12 | 8.75 | 4 | 9 |
| A | | | | | | |
| Composition | 8.75 | 4 | 9 | 8.75 | 4 | 9 |
| F | | | | | | |
| Composition | 8.5 | 5 | 9 | 8.5 | 4 | 10 |
| A | | | | | | |
| Composition | 8.5 | 4 | 9 | 8.75 | 4 | 12 |
| F | | | | | | |

### Example 5—Testing Results Using Blender

Blender testing was performed according to the method described in Example 2 using Composition A and Composition F. For testing, each run was prepared by adding 3 drops of the sample in 1030 mL 15:1 Test Coolant Fluid to generate the fluid tested and the results were observed. The results are summarized below in Table 2.

TABLE 2
Summary of blender testing of Composition
A and Composition F in 15:1 Test Coolant.

| | | | | Foam | Foam | Entrained |
|---|---|---|---|---|---|---|
| | | | Blender | Height | Height | Air Height |
| | | Majority/Large | Blades | at | at | at 3 |
| | Test | bubbles done | Visibile | 2 min | 3 min | minutes |
| Sample | Fluid | (seconds) | (seconds) | (mm) | (mm) | (Liters) |
| Composition | 15:1 Test | 25 | Not | 3 | 3 | 0 |
| A | Coolant | | observed | | | |
| | Fluid | | | | | |
| Composition | 15:1 Test | 18 | Not | 0 | 0 | 0 |
| F | Coolant | | observed | | | |
| | Fluid | | | | | |

The uses of the terms “a” and “an” and “the” and similar references in the context of the disclosure (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the foregoing description, the same is to be considered as illustrative and not restrictive in character, it being understood that all changes and modifications that come within the spirit of the invention are desired to be protected. In addition, all references cited herein are indicative of the level of skill in the art and are hereby incorporated by reference in their entirety.

### Embodiments

The following provides an enumerated listing of some of the embodiments disclosed herein. It will be understood that this listing is non-limiting, and that individual features or combinations of features (e.g. 2, 3 or 4 features) as described in the Detailed Description above can be incorporated with the below-listed Embodiments to provide additional disclosed embodiments herein.

1. A composition of matter comprising
an alkyloxylated decyne diol; and
and additive, wherein the additive comprises aminoethyl propane diol, a glycol ether, a polydimethylsiloxane or a combination thereof.

2. The composition of matter of embodiment 1, wherein the alkyloxylated decyne diol comprises [(2-Ethylhexyl)methyl]oxirane reacted with polyethylene glycol and 2,4,7,9-Tetramethyl-5-decyne-4,7-diol.

3. The composition of matter of embodiment 1 wherein the additive comprises an aminoethyl propane diol.

4. The composition of embodiment 3, wherein the aminoethyl propane diol comprises 2-amino-2-ethyl-1,3-propanediol.

5. The composition of embodiment 1, wherein the additive comprises a glycol ether.

6. The composition of embodiment 5, wherein the glycol ether comprises a polyalkylene glycol.

7. The composition of matter of embodiment 5, wherein the glycol ether comprises a Polypropylene glycol monobutyl ether.

8. The composition of matter of embodiment 5, wherein the glycol ether comprises polypropylene glycol monobutyl ether polymers with a viscosity between 65 and 1750 Saybolt Universal Seconds.

9. The composition of any one of embodiments 1-8, wherein the alkyloxylated decyne diol comprises between 80 percent by weight to 99.6 percent by weight of the composition.

10. The composition of embodiment 9 wherein the alkyloxylated decyne diol comprises between 90 percent by weight to 99.6 percent by weight of the composition.

11. The composition of embodiment 10 wherein the alkyloxylated decyne diol comprises between 95 percent by weight to 99.6 percent by weight of the composition.

12. The composition of embodiment 11 wherein the alkyloxylated decyne diol comprises between 98 percent by weight to 99.6 percent by weight of the composition.

13. The composition of embodiment 12 wherein the alkyloxylated decyne diol comprises between 99.0 percent by weight to 99.6 percent by weight of the composition.

14. The composition of any one prior embodiment, wherein the additive comprises between 0.2 percent by weight to 5 percent by weight.

15. The composition of embodiment 14, wherein the additive comprises between 0.2 percent by weight to 4 percent by weight.

16. The composition of embodiment 15, wherein the additive comprises between 0.2 percent by weight to 3 percent by weight.

17. The composition of embodiment 16, wherein the additive comprises between 0.2 percent by weight to 2 percent by weight.

18. The composition of embodiment 17, wherein the additive comprises between 0.2 percent by weight to 1 percent by weight.

19. A method for reducing the quantity of foam in a composition of matter used for grinding or polishing ophthalmic lens or precision optical components comprising the acts of:
providing a first composition of matter comprising the composition of matter of any one of embodiments 1-18;
providing a second composition of matter;
adding the first composition of matter to the second composition of matter.

20. The method of embodiment 19, wherein the second composition of matter comprises a coolant fluid or water.

21. A method for grinding or polishing a lens comprising grinding or polishing a substrate in the presence of a composition of matter comprising any one of any of embodiments 1-18.

22. The method of embodiment 21, wherein the substrate comprises glass, automotive glass, flat glass, ophthalmic glass, precision ophthalmic glass, ceramics, quartz, solar glass, optical glass, precision optical substrates, lens glass, architectural glass, curtain wall glass, appliance glass, electronic-device glass, and/or plastics such as, but not limited to, ophthalmic plastics.

1. A composition of matter comprising
an alkyloxylated decyne diol; and
and additive, wherein the additive comprises aminoethyl propane diol, a glycol ether, a polydimethylsiloxane or a combination thereof.

2. The composition of matter of claim 1, wherein the alkyloxylated decyne diol comprises [(2-Ethylhexyl)methyl]oxirane reacted with polyethylene glycol and 2,4,7,9-Tetramethyl-5-decyne-4,7-diol.

3. The composition of matter of claim 1 wherein the additive comprises an aminoethyl propane diol.

4. The composition of claim 3, wherein the aminoethyl propane diol comprises 2-amino-2-ethyl-1,3-propanediol.

5. The composition of claim 1, wherein the additive comprises a glycol ether.

6. The composition of claim 5, wherein the glycol ether comprises a polyalkylene glycol.

7. The composition of matter of claim 5, wherein the glycol ether comprises a Polypropylene glycol monobutyl ether.

8. The composition of matter of claim 5, wherein the glycol ether comprises polypropylene glycol monobutyl ether polymers with a viscosity between 65 and 1750 Saybolt Universal Seconds.

9. The composition of claim 1, wherein the alkyloxylated decyne diol comprises between 80 percent by weight to 99.6 percent by weight of the composition.

10. The composition of claim 9 wherein the alkyloxylated decyne diol comprises between 90 percent by weight to 99.6 percent by weight of the composition.

11. The composition of claim 10 wherein the alkyloxylated decyne diol comprises between 95 percent by weight to 99.6 percent by weight of the composition.

12. The composition of claim 11 wherein the alkyloxylated decyne diol comprises between 98 percent by weight to 99.6 percent by weight of the composition.

13. The composition of claim 12 wherein the alkyloxylated decyne diol comprises between 99.0 percent by weight to 99.6 percent by weight of the composition.

14. The composition of any one prior claim 1, wherein the additive comprises between 0.2 percent by weight to 5 percent by weight.

15. The composition of claim 14, wherein the additive comprises between 0.2 percent by weight to 4 percent by weight.

16. The composition of claim 15, wherein the additive comprises between 0.2 percent by weight to 3 percent by weight.

17. The composition of claim 16, wherein the additive comprises between 0.2 percent by weight to 2 percent by weight.

18. The composition of claim 17, wherein the additive comprises between 0.2 percent by weight to 1 percent by weight.

19. A method for reducing the quantity of foam in a composition of matter used for grinding or polishing ophthalmic lens or precision optical components comprising the acts of:
providing a first composition of matter comprising the composition of matter of claim 1;
providing a second composition of matter;
adding the first composition of matter to the second composition of matter.

20. The method of claim 19, wherein the second composition of matter comprises a coolant fluid or water.

21. A method for grinding or polishing a lens comprising grinding or polishing a substrate in the presence of a composition of matter comprising claim 1.

22. The method of claim 21, wherein the substrate comprises glass, automotive glass, flat glass, ophthalmic glass, precision ophthalmic glass, ceramics, quartz, solar glass, optical glass, precision optical substrates, lens glass, architectural glass, curtain wall glass, appliance glass, electronic-device glass, and/or plastics such as, but not limited to, ophthalmic plastics.
